(19) United States
(12) Patent Application Publication
(10) Pub. No.: US 2012/0050195 A1
(43) Pub. Date: Mar. 1, 2012

(54) ON-CELL TSP DISPLAY DEVICE

(75) Inventors: Hoon Do HEO, Suwon-si (KR); Dong Sub KIM, Suwon-si (KR); Sang Yong EOM, Suwon-si (KR)

(73) Assignee: SAMSUNG ELECTRONICS CO. LTD., Suwon-si (KR)

(21) Appl. No.: 13/214,678

(22) Filed: Aug. 22, 2011

(30) Foreign Application Priority Data
Aug. 26, 2010 (KR) 10-2010-0082788

(51) Int. Cl. G06F 3/041

(52) U.S. Cl. 345/173

(57) ABSTRACT

An on-cell Touch Screen Panel (TSP) display device is provided. The on-cell TSP display device includes a touch screen, at least one touch key, a controller, a touch screen and touch key information processor for determining touch data input by the touch screen and touch data input by the touch key and for transmitting a corresponding signal to the controller.

### PRIORITY

This application claims the benefit under 35 U.S.C. §119(a) of a Korean patent application filed on Aug. 26, 2010 in the Korean Intellectual Property Office and assigned Serial No. 10-2010-0082788, the entire disclosure of which is hereby incorporated by reference.

### BACKGROUND OF THE INVENTION

1. Field of the Invention

The present invention relates to an on-cell Touch Screen Panel (TSP) display device. More particularly, the present invention relates to an on-cell TSP display device that simultaneously implement a touch key and a touch screen with one information processor by forming a touch screen pattern at an upper surface of a display.

2. Description of the Related Art

Recently, in order to increase a display area while reducing weight and thickness of a mobile terminal, touch screen technology has been applied to the mobile terminal Such touch screen technology includes a method of forming a touch screen pattern in a low surface of a window and an on-cell Touch Screen Panel (TSP) method for forming a touch screen pattern in an upper surface of a display. In the former, because an air gap is formed between a display and a window in which a touch screen pattern is formed in a low surface, light is reflected due to a refractive index difference. As a result, it is difficult to view a clear screen under strong external light. Therefore, an on-cell TSP is generally used to view a clear screen.

FIG. 1 is a schematic cross-sectional view illustrating an on-cell TSP display device according to the related art. FIG. 2 is a plan view illustrating a connection structure of a touch key Integrated Circuit (IC), a touch key Flexible Printed Circuit Board (FPCB), a touch screen IC, and a touch screen FPCB of an on-cell TSP display device according to the related art.

Referring to FIGS. 1 and 2, the on-cell TSP display device 100 includes a display 140 having a touch screen pattern 130 located in an upper surface thereof, resin 120 formed on an upper part of the touch screen pattern 130, and a window 110 formed on an upper surface of the resin 120. When the display 140 is an Active Matrix Organic Light-Emitting Diode (AMOLED), a polarizing plate (not illustrated) is disposed between the resin 120 and the touch screen pattern 130. A touch key FPCB 160 is formed on a lower part of a touch key (not illustrated) formed at one end of the window 110. The touch key FPCB includes a first touch sensor 165a, a second touch sensor 165b and a third touch sensor 165c. The touch key FPCB 160 is connected to a touch key IC 163 by a cable 161, and the touch key IC 163 is connected to a touch screen FPCB 150 by a cable 162 and a connector 164. The touch screen FPCB 150 has a touch screen IC 151 at an upper surface thereof and is connected to the touch screen pattern 130 by a connection portion 152.

In the on-cell TSP display device 100, a touch key (not illustrated) is formed at one end of the window 110, and the touch screen pattern 130 is formed at an upper surface of the display 140 instead of the window 110 and thus an IC and FPCB for processing touch data are separately formed in a touch screen and a touch key, respectively. Therefore, as a structure for processing touch data becomes complex, it is difficult to manufacture the structure and to reduce production costs.

### SUMMARY OF THE INVENTION

Aspects of the present invention are to address the above mentioned problems and/or disadvantages and to provide the advantages described below. Accordingly, an aspect of the present invention is to provide an on-cell Touch Screen Panel (TSP) display device that can simplify a touch screen and a touch key by implementing the touch screen and the touch key with a touch data processor that is easily manufactured and has reduced production costs.

In accordance with an aspect of the present invention, an on-cell TSP display device comprising a touch screen, at least one touch key, and a controller is provided. The on-cell TSP display device comprises a touch screen and touch key information processor for determining touch data that are input via the touch screen and touch data that are input via the at least one touch key, and for transmitting a corresponding signal to the controller.

In accordance with another aspect of the present invention, an on-cell Touch Screen Panel (TSP) display device comprising a touch screen is provided. The device includes a plurality of touch sensors corresponding to a plurality of touch keys, a controller for receiving a signal corresponding to touch data that is input via the touch screen and one or more of the plurality of touch keys, and a touch screen and touch key information processor coupled to the plurality of touch sensors for determining at least one of touch data input by the touch screen and touch data input by one or more of the plurality of touch keys, and for transmitting a corresponding signal to the controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic cross-sectional view illustrating an on-cell Touch Screen Panel (TSP) display device according to the related art;

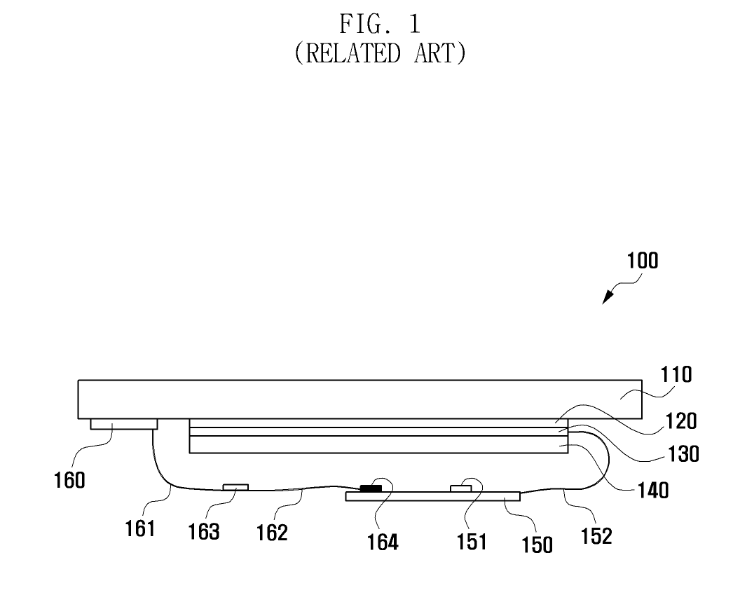

FIG. 2 is a plan view illustrating a connection structure of a touch key Integrated Circuit (IC), a touch key Flexible Printed Circuit Board (FPCB), a touch screen IC, and a touch screen FPCB of an on-cell TSP display device according to the related art;

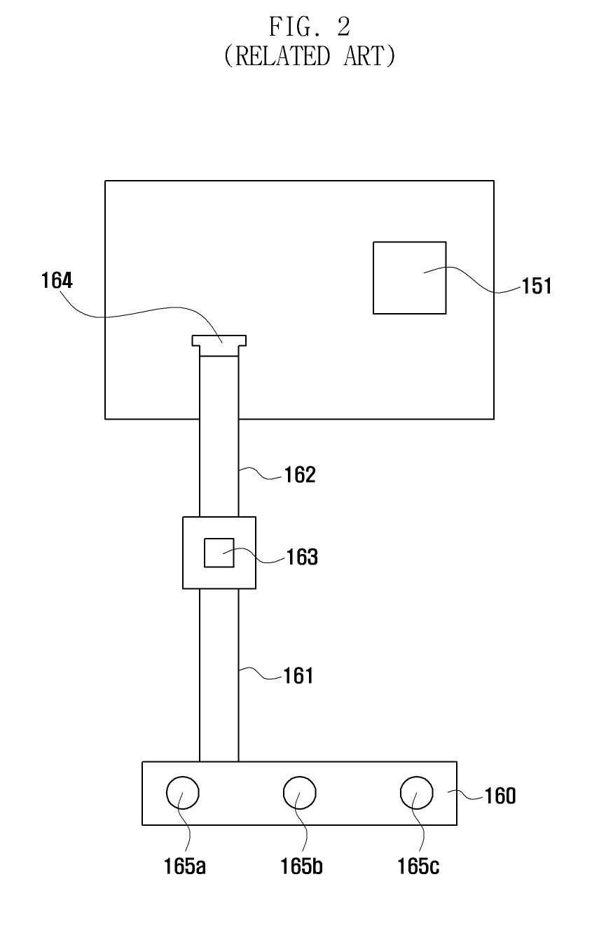

FIG. 3 is a block diagram illustrating a configuration of an on-cell TSP display device according to an exemplary embodiment of the present invention;

FIG. 4 is a schematic cross-sectional view illustrating an on-cell TSP display device according to an exemplary embodiment of the present invention;

FIG. 5 is a schematic plan view illustrating an FPCB of the on-cell TSP display device according to an exemplary embodiment of the present invention; and

FIG. 6 is a plan view illustrating an electrode pattern of touch sensors of an FPCB according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

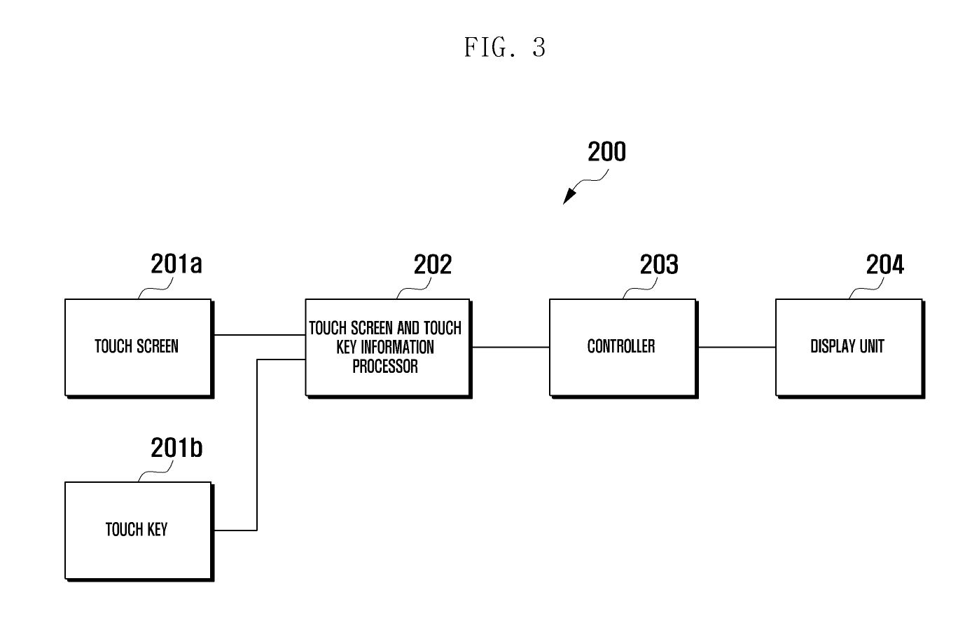

FIGS. 3 through 6, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

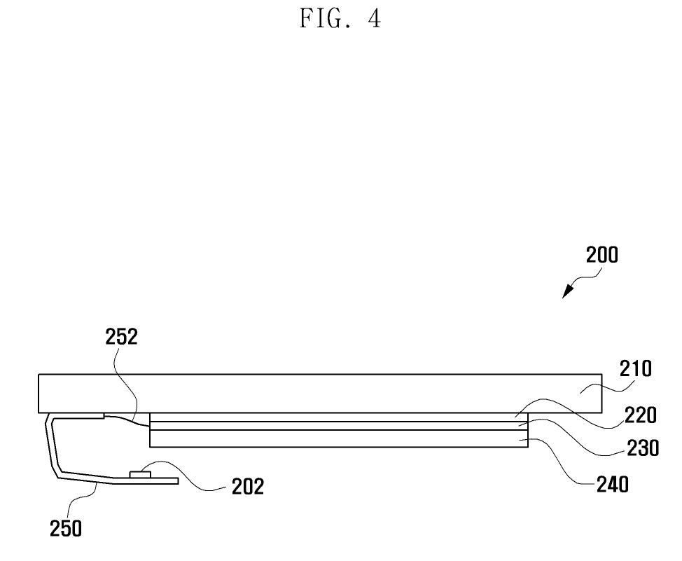

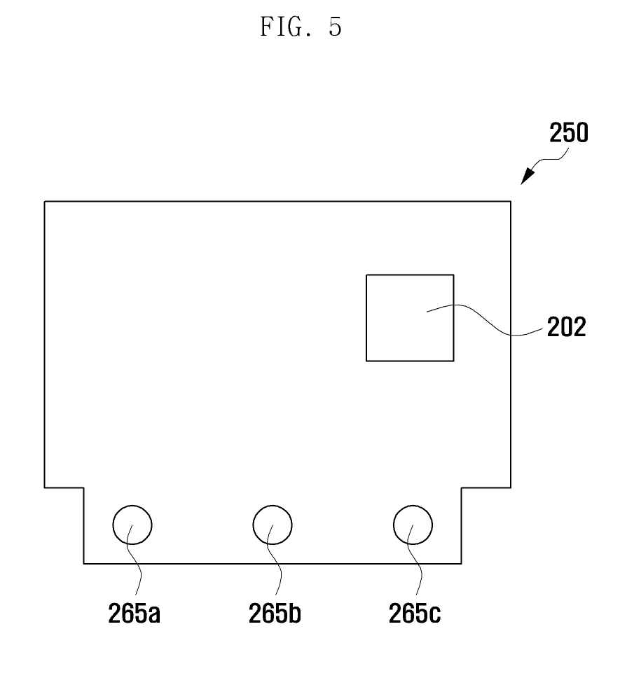

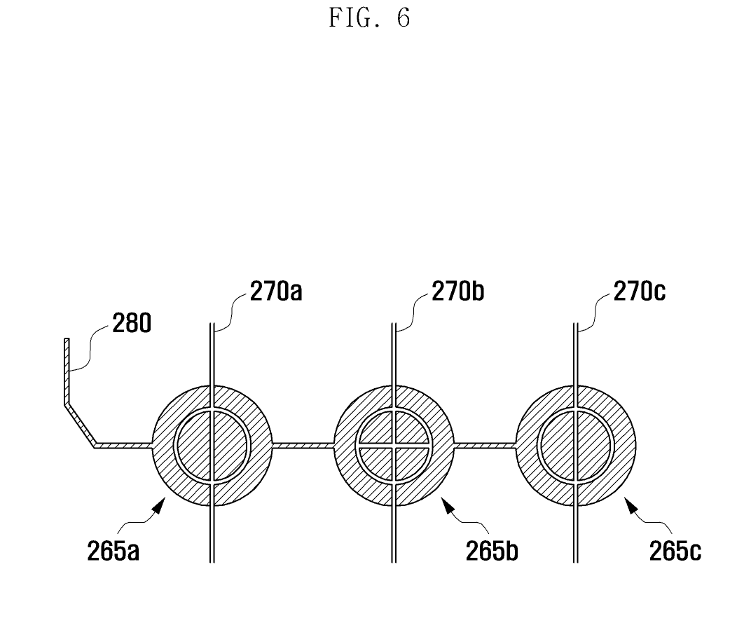

FIG. 3 is a block diagram illustrating a configuration of an on-cell Touch Screen Panel (TSP) display device according to an exemplary embodiment of the present invention. FIG. 4 is a schematic cross-sectional view illustrating an on-cell TSP display device according to an exemplary embodiment of the present invention. FIG. 5 is a schematic plan view illustrating a Flexible Printed Circuit Board (FPCB) of an on-cell TSP display device according to the related art. FIG. 6 is a plan view illustrating an electrode pattern of touch sensors of an FPCB according to the related art.

Referring to FIG. 3, the on-cell TSP display device 200 includes a touch screen 201a, a touch key 201b, a touch screen and a touch key information processor 202, a controller 203, and a display unit 204.

Referring to FIGS. 3 to 6, the touch screen 201a includes a display 240 and a touch screen pattern 230 for detecting a touch operation. The touch screen pattern 230 is formed at an upper surface of the display 240. Although not illustrated in FIG. 4, the touch key 201b is formed at one end of a window. In an exemplary embodiment of the present invention, the on-cell TSP display device 100 includes three (3) touch keys. However, the present invention is not limited thereto. For example, the on-cell TSP display device 100 may include one (1) touch key, two (2) touch keys, or four (4) or more touch keys.

The touch screen and touch key information processor 202 performs a function of recognizing input touch data and transmitting the recognized touch data to the controller 203, and touch sensors 265a, 265b, and 265c corresponding to each of the touch keys 201b. The touch sensors 265a, 265b, and 265c are mounted on a FPCB 250 at one end and are formed as an Integrated Circuit (IC). Each of the touch sensors 265a, 265b, and 265c is disposed adjacent to a low surface of a corresponding touch key. One end of the FPCB 250 is connected to the touch screen pattern 230 by a connection portion 252. The touch screen and touch key information processor 202 transmits a signal corresponding to touch data that is input via the touch screen 201a to the controller 203 when touch data are input via the touch screen 201a and transmits a signal corresponding to touch data that are input via the touch key 201b to the controller 203 when touch data are input via the touch key 201b.

In FIG. 6, in order to transmit touch data that are input via a corresponding touch key, each of the first touch sensor 265a, the second touch sensor 265b, and the third touch sensor 265c uses one of x-channels of the touch screen. The touch screen operates according to a method in which a y-channel receives a signal of an x-channel and transmits touch data to the touch screen and touch key information processor 202. Thus, the x-channel may be used rather than the y-channel. For example, when the x-channels of the touch screen are formed with an x1 channel, an x2 channel, an x3 channel, an x4 channel , . . . , an xm channel, an x-channel 270a for passing through the first touch sensor 265a, an x-channel 270b for passing through the second touch sensor 265b, and an x-channel 270c for passing through the third touch sensor 265c may be the x1 channel, the x2 channel, and the x3 channel, respectively, or may be the x2 channel, the x3 channel, and the x4 channel. Although not illustrated in FIG. 5, upper end portions of each of the x-channel 270a for passing through the first touch sensor 265a, the x-channel 270b for passing through the second touch sensor 265b, and the x-channel 270c for passing through the third touch sensor 265c that are illustrated in FIG. 6 are connected to the touch screen and touch key information processor 202, and lower end portions thereof that are connected to the connection portion 252 are connected to the touch screen pattern 230.

Further, the first touch sensor 265a, the second touch sensor 265b, and the third touch sensor 265c are connected by a touch key identification channel 280 for transmitting a signal for identifying that touch data are input via the touch key 201b. The touch key identification channel 280 is electrically insulated from the x-channel 270a for passing through the first touch sensor 265a, the x-channel 270b for passing through the second touch sensor 265b, and the x-channel 270c for passing through the third touch sensor 265c. For example, if y-channels of the touch screen are formed with an y1 channel, an y2 channel, an y3 channel, an y4 channel, . . . , and an yn channel, by additionally allocating an yn+1 channel, this channel may be used as the touch key identification channel 280. Although not illustrated in FIG. 5, an upper end portion of the touch key identification channel 280 illustrated in FIG. 6 is connected to the touch screen and touch key information processor 202.

Although not illustrated in FIG. 4, the controller 203 performs a function of receiving touch screen information or touch key information from the touch screen and touch key information processor 202 and of controlling the display unit 204.

The display unit 204 includes a window 210 and the display 240 and performs a function of receiving a control signal from the controller 203 and displaying a screen. In the on-cell TSP display device according to an exemplary embodiment of the present invention, resin 220 is formed on a lower surface of the window 210. When the display 240 is an Active Matrix Organic Light Emitting Diode (AMOLED), a polarizing plate (not illustrated) is disposed between the resin 220 and the touch screen pattern 230.

According to an exemplary embodiment of the present invention, because touch data that are input via a touch screen and touch data that are input via a touch key are processed using the touch screen and touch key information processor 202, the quantity of ICs for processing touch data is smaller than the quantity of ICs according to the related art, Thus, a structure for processing touch data can be simplified and production costs can be reduced. Further, because the touch screen and touch key information processor 202 and the touch sensors 265a, 265b, and 265c are formed together in one FPCB 250, the quantity of FPCBs in which touch data are transmitted is smaller than the quantity of FPCBs in the related art. Thus, a structure for processing touch data can be more easily implemented. Further, when transmitting touch data that are input via the touch key, because only one touch key identification channel 280 is additionally allocated while sharing an x-channel of the touch screen by the quantity of the touch sensors 265a, 265b, and 265c, when the quantity of the touch sensor is k, the quantity of channels for the touch sensor can be smaller by the quantity k−1 than in the related art.

As described above, according to exemplary embodiments of the present invention, by processing touch data that are input via a touch screen and touch data that are input via a touch key using a touch screen and touch key information processor, a structure for processing touch data can be simplified and production costs can be reduced. Further, because the touch screen and touch key information processor and the touch sensor are formed together in one FPCB, a structure for processing touch data can be more easily implemented.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. An on-cell Touch Screen Panel (TSP) display device comprising a touch screen, at least one touch key, and a controller, the device comprising:
a touch screen and touch key information processor for determining touch data input via the touch screen and touch data input via the at least one touch key and for transmitting a corresponding signal to the controller.

2. The device of claim 1, wherein the touch screen and touch key information processor is mounted on a Flexible Printed Circuit Board (FPCB) and is coupled to a touch sensor corresponding to each of the at least one touch key at one end of the FPCB.

3. The device of claim 2, wherein the one end of the FPCB is connected to a touch screen pattern of the touch screen.

4. The device of claim 2, wherein the at least one touch key and the corresponding touch sensor are each formed in plural.

5. The device of claim 4, wherein each touch sensor uses one of a plurality of x-channels of the touch screen in order to transmit touch data input via a corresponding touch key of the at least one touch key.

6. The device of claim 5, wherein the touch screen comprises a y-channel for receiving a signal of an x-channel.

7. The device of claim 6, wherein each touch sensor is connected via a touch key identification channel for transmitting a signal for identifying that touch data is input by a corresponding touch key of the at least one touch key.

8. The device of claim 7, wherein the touch key identification channel comprises an additionally allocated y-channel.

9. An on-cell Touch Screen Panel (TSP) display device comprising a touch screen, the device comprising:
a plurality of touch sensors corresponding to a plurality of touch keys;
a controller for receiving a signal corresponding to touch data that is input via the touch screen and one or more of the plurality of touch keys; and
a touch screen and touch key information processor coupled to the plurality of touch sensors for determining at least one of touch data input by the touch screen and touch data input by one or more of the plurality of touch keys, and for transmitting a corresponding signal to the controller.

10. The device of claim 9, wherein the touch screen and touch key information processor is mounted on a Flexible Printed Circuit Board (FPCB) and is coupled to the plurality of touch sensors at one end of the FPCB.

11. The device of claim 10, wherein the one end of the FPCB is connected to a touch screen pattern of the touch screen.

12. The device of claim 10, wherein each of a plurality of touch sensors uses one of a plurality of x-channels of the touch screen in order to transmit touch data input by a corresponding touch key of the plurality of touch keys.

13. The device of claim 12, wherein the touch screen comprises a y-channel for receiving a signal of an x-channel.

14. The device of claim 13, wherein the plurality of touch sensors are connected via a touch key identification channel for transmitting a signal for identifying that touch data is input by a corresponding touch key of the plurality of touch keys.

15. The device of claim 14, wherein the touch key identification channel comprises an additionally allocated y-channel.
